(19) United States
(12) Patent Application Publication
(10) Pub. No.: US 2023/0214277 A1
(43) Pub. Date: Jul. 6, 2023

(54) SYSTEMS AND METHODS TO IMPROVE SOFTWARE APPLICATION PERFORMANCE

(71) Applicant: CITRIX SYSTEMS, INC., Fort Lauderdale, FL (US)

(72) Inventors: Shihao Qian, Nanjing (CN); Bo Zang, Nanjing (CN); Hao Wu, Nanjing (CN); Yihong Wu, Nanjing (CN)

(21) Appl. No.: 17/578,338

(22) Filed: Jan. 18, 2022

Related U.S. Application Data
(63) Continuation of application No. PCT/CN22/70017, filed on Jan. 4, 2022.

(51) Int. Cl. G06F 9/54; G06N 20/00

(52) U.S. Cl. CPC G06F 9/542; G06N 20/00; G06F 9/547; G06F 2209/544

(57) ABSTRACT

A method for learning model based attribute impact analysis may include training a learning model to recognize a nexus between a name of a file and an attribute impacted by the file. The trained learning model may be applied to identify at least one attribute impacted by a file update including one or more files. A review may be performed of the at least one attribute impacted by the file update. Related systems and computer program products are also provided.

### CROSS REFERENCE TO RELATED APPLICATIONS

This application is a Bypass Continuation Application of International Application No. PCT/CN2022/070017, filed Jan. 4, 2022 and entitled “SYSTEMS AND METHODS TO IMPROVE SOFTWARE APPLICATION PERFORMANCE,” the disclosure of which is incorporated herein by reference in its entirety.

### TECHNICAL FIELD

The subject matter described herein relates generally to computing systems and more specifically to techniques for notification about changes to files.

### BACKGROUND

Cloud computing can include the on-demand availability of a pool of shared computing resources, such as computer networks, server, data storage, software applications, and services, without direct active management by the user. The phrase can be generally used to describe data centers available to many users over the Internet. Large clouds often have functions distributed over multiple locations from central servers.

Some cloud computing providers can allow for scalability and elasticity via dynamic (e.g., “on-demand”) provisioning of resources on a fine-grained, self-service basis. This can provide cloud computing users the ability to scale up when the usage need increases or down if resources are not being used.

### SUMMARY

Methods, systems, and articles of manufacture, including computer program products, are provided for attribute impact analysis. In one aspect, there is provided a system including at least one data processor and at least one memory. The at least one memory may store instructions, which when executed by the at least one data processor, cause the at least one data processor to at least: determine, based at least on a historical data, a frequency with which modifying a file impacts an attribute of a first remote application; in response to a change to the file, generate a function call to cause the first remote application and/or a second remote application to generate a notification indicative of the attribute being impacted by the change to the file; and execute the function call to cause the first remote application and/or the second remote application to generate the notification.

In some variations, one or more of the features disclosed herein including the following features can optionally be included in any feasible combination. The at least one processor may be further caused to at least: train, based at least on the frequency with which modifying the file impacts the attribute of the first remote application, a learning model recognize a nexus between a name of the file and the attribute impacted by modifying the file; apply the trained learning model to identify at least one attribute impacted by a file update including one or more files; and perform a review of the at least one attribute impacted by the file update.

In some variations, the at least one data processor may be further caused to at least: retrieve, for each file of a plurality of files included in one or more file updates known to impact the at least one attribute, a corresponding name; determine a frequency of each file having a same or similar name; determine a weight for each file having an above-threshold frequency; and generate, based at least on the weight associated with each file having the above-threshold frequency, the trained learning model.

In some variations, the at least one data processor may be further caused to at least: compute a similarity metric between a first text string corresponding a first name of a first file from the file update and a second text string corresponding to a second name of a second file included in the trained learning model; and assign, to the first file, a first weight corresponding to a second weight of the second file in the trained learning model.

In some variations, the similarity metric may include one or more of edit distance, Minkowski distance, Manhattan distance, Euclidean distance, Hausdorff distance, Damerau-Levenshtein distance, Sorensen-Dice coefficient, block distance, Hamming distance, Jaro-Winkler distance, simple matching coefficient (SMC), Jaccard coefficient, Tversky index, overlap coefficient, variational distance, Hellinger distance, information radius, skew divergence, confusion probability, Tau metric, Fellegi and Sunters metric (SFS), maximal matches, grammar-based distance, or term frequency inverse document frequency (TFIDF) distance metric.

In some variations, the at least one data processor may be further caused to at least: determine, based at least on a combined weight of the one or more files satisfying a first threshold value, that the file update impacts the at least one attribute.

In some variations, the at least one data processor may be further caused to at least: in response to the combined weight of the one or more files failing to satisfy the first threshold value, determine whether an individual weight of each of the one or more files satisfy a second threshold value; and determine, based at least on the individual weight of each of the one or more files satisfying the second threshold value, that the file update impacts the at least one attribute.

In some variations, the weight associated with each file may correspond to a ratio between the frequency of each file and an aggregate frequencies of all files known to impact the attribute.

In some variations, the at least one data processor may be further caused to at least: retrieve, based at least on an identifier of the file update, the one or more files included in the file update.

In some variations, the at least one data processor may be further caused to at least: receive a user input including an identifier of an issue tracking ticket associated with the file update; and apply the trained learning model to identify the at least one attribute impacted by the one or more files in response to user input.

In some variations, the at least one data processor may be further caused to at least: detect a pull request (PR) committing the one or more files; and apply the trained learning model to identify the at least one attribute impacted by the one or more files in response to detecting the pull request.

In some variations, the attribute may include security or globalization.

In another aspect, there is provided a method for attribute impact analysis. The method may include: determining, based at least on a historical data, a frequency with which modifying a file impacts an attribute of a first remote application; in response to a change to the file, generating a function call to cause the first remote application and/or a second remote application to generate a notification indicative of the attribute being impacted by the change to the file; and executing the function call to cause the first remote application and/or the second remote application to generate the notification.

In some variations, one or more of the features disclosed herein including the following features can optionally be included in any feasible combination. The method may further include: training, based at least on the frequency with which modifying the file impacts the attribute of the first remote application, a learning model recognize a nexus between a name of the file and the attribute impacted by modifying the file; applying the trained learning model to identify at least one attribute impacted by a file update including one or more files; and performing a review of the at least one attribute impacted by the file update.

In some variations, the method may further include: retrieving, for each file of a plurality of files included in one or more file updates known to impact the at least one attribute, a corresponding name; determining a frequency of each file having a same or similar name; determining a weight for each file having an above-threshold frequency; and generating, based at least on the weight associated with each file having the above-threshold frequency, the trained learning model.

In some variations, the method may further include: computing a similarity metric between a first text string corresponding a first name of a first file from the file update and a second text string corresponding to a second name of a second file included in the trained learning model; and assigning, to the first file, a first weight corresponding to a second weight of the second file in the trained learning model.

In some variations, the method may further include: determining, based at least on a combined weight of the one or more files satisfying a first threshold value, that the file update impacts the at least one attribute; in response to the combined weight of the one or more files failing to satisfy the first threshold value, determining whether an individual weight of each of the one or more files satisfy a second threshold value; and determining, based at least on the individual weight of each of the one or more files satisfying the second threshold value, that the file update impacts the at least one attribute.

In some variations, the weight associated with each file may correspond to a ratio between the frequency of each file and an aggregate frequencies of all files known to impact the attribute.

In some variations, the method may further include: retrieving, based at least on an identifier of the file update, the one or more files included in the file update.

In another aspect, there is provided a computer program product that includes a non-transitory computer readable storage medium. The non-transitory computer-readable storage medium may include program code that causes operations when executed by at least one data processor. The operations may include: training, based at least on the frequency with which modifying the file impacts the attribute of the first remote application, a learning model recognize a nexus between a name of the file and the attribute impacted by modifying the file; applying the trained learning model to identify at least one attribute impacted by a file update including one or more files; and performing a review of the at least one attribute impacted by the file update.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to attribute impact analysis for targeted review, it should be readily understood that such features are not intended to be limiting. The claims that follow this disclosure are intended to define the scope of the protected subject matter.

### DESCRIPTION OF DRAWINGS

FIG. 1A depicts a system diagram illustrating an example of an instrumentation system, in accordance with some example embodiments;

FIG. 1B depicts a block diagram illustrating the architecture of an example of an instrumentation system, in accordance with some example embodiments;

FIG. 2 depicts a flowchart illustrating an example of a process for learning model based attribute impact analysis, in accordance with some example embodiments;

FIG. 3A depicts a flowchart illustrating an example of a process for training a learning model to perform attribute impact analysis, in accordance with some example embodiments;

FIG. 3B depicts a flowchart illustrating an example of a process for learning model based attribute impact analysis, in accordance with some example embodiments;

FIG. 4A depicts a screenshot illustrating an example of a user interface for attribute impact analysis, in accordance with some example embodiments;

FIG. 4B depicts a screenshot illustrating another example of a user interface for attribute impact analysis, in accordance with some example embodiments;

FIG. 4C depicts a screenshot illustrating another example of a script for attribute impact analysis, in accordance with some example embodiments;

FIG. 4D depicts a screenshot illustrating another example of a user interface for attribute impact analysis, in accordance with some example embodiments;

FIG. 5A depicts a network diagram illustrating an example of a network environment, in accordance with some example embodiments;

FIG. 5B depicts a block diagram illustrating an example of a computing device, in accordance with some example embodiments;

FIG. 5C depicts a high-level architecture of an example of a virtualization system for implementing a computing system, in accordance with some example embodiments.

When practical, like reference symbols in the various drawings indicate like elements.

### DETAILED DESCRIPTION

Cloud providers can provide a remote computing environment, for example, with virtual machine (VM) infrastructure such as a hypervisor using native execution to share and manage hardware, allowing for multiple computing environments which are isolated from one another, yet exist on the same physical machine. The computing environment can include an infrastructure as a service (IaaS) platform that provides application programming interfaces (APIs) to dereference low-level details of underlying network infrastructure. In such an infrastructure as a service platform, pools of hypervisors can support large numbers of virtual machines and include the ability to scale up and down services to meet varying needs. Infrastructure as a service platforms can provide the capability to the user to provision processing, storage, networks, and other fundamental computing resources where the user is able to deploy and run arbitrary software, which can include operating systems and applications.

Changes to one or more files associated with a software application, such as code files and configuration files, may alter one or more attributes of the software application including its functionalities and behavior. For example, the development and/or update of a software application may include a sequence of stages including, for example, development, testing, acceptance, production, and/or the like. However, even minor updates to the code files of the software application that affect very few lines of programming code may trigger significant and often unpredictable changes to the attributes of the software application, not all of which are undesirable to the end user. For instance, changing the programming code of the software application may engender a security impact by introducing security vulnerabilities to the software application. Alternatively and/or additionally, changing the programming code of the software application may engender a globalization impact and prevent the software application from being localized at a specific locale or across multiple locales.

Consistent and thorough review of the files associated with a software application may be necessary for individual updates that change the configuration or programming code of the software application in order to ensure that the software application remains compatible with its production environment and functionally available. However, when the software application requires frequent updates, such as a legacy software application with many defects and outdated features, conventional techniques for reviewing the files associated with the software application for individual updates may consume excessive resources. As such, in some example embodiments, a learning model may be trained to identify one or more attributes of the software application impacted by a change to one or more files associated with a software application. Doing so may enable a targeted review of the files that examines the attributes identified by the learning model as being impacted by the update to the software application. Subsequent review of the files associated with the software application may there be rendered more precise and resource efficient.

In some example embodiments, the learning model may be trained to recognize a nexus between the name of a file and the attributes impacted by the file. For example, the learning model be trained to recognize the file as impacting a particular attribute, such as security or globalization, based at least on a frequency of a file having a same (or similar) name being identified as impacting that attribute. Accordingly, when the learning model encounters an update to a software application that includes the file, the learning model may identify the attribute impacted by the update based at least on the frequency of the file having a same (or similar) name being identified as impacting that attribute. The files associated with the software application may subsequently undergo a targeted review that is focused on the attributes identified as being impacted by the update to the software application. The targeted review may be more precise and resource efficient at least because the review may avoid those attributes not impacted by the update to the software application. As such, updates to the software application, which may be especially frequent for certain software applications, may be ready for deployment in less time and with less detriment to the functional availability of the software application.

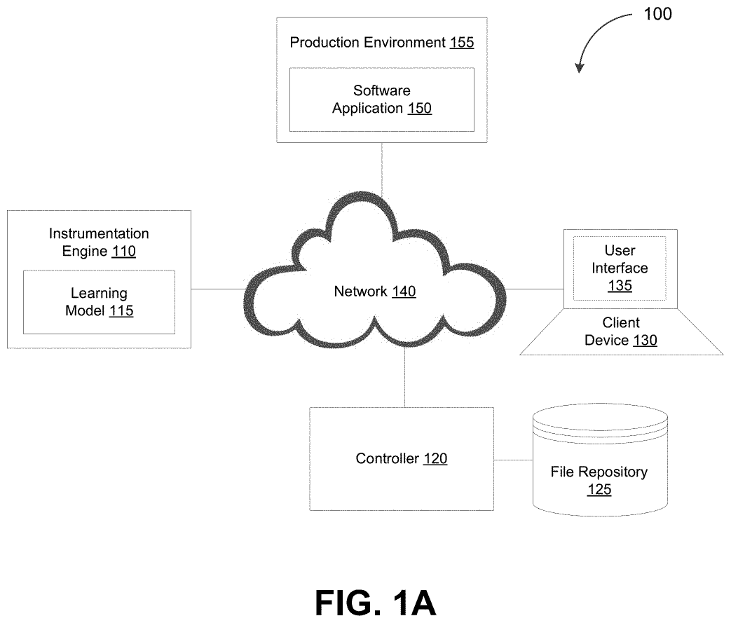

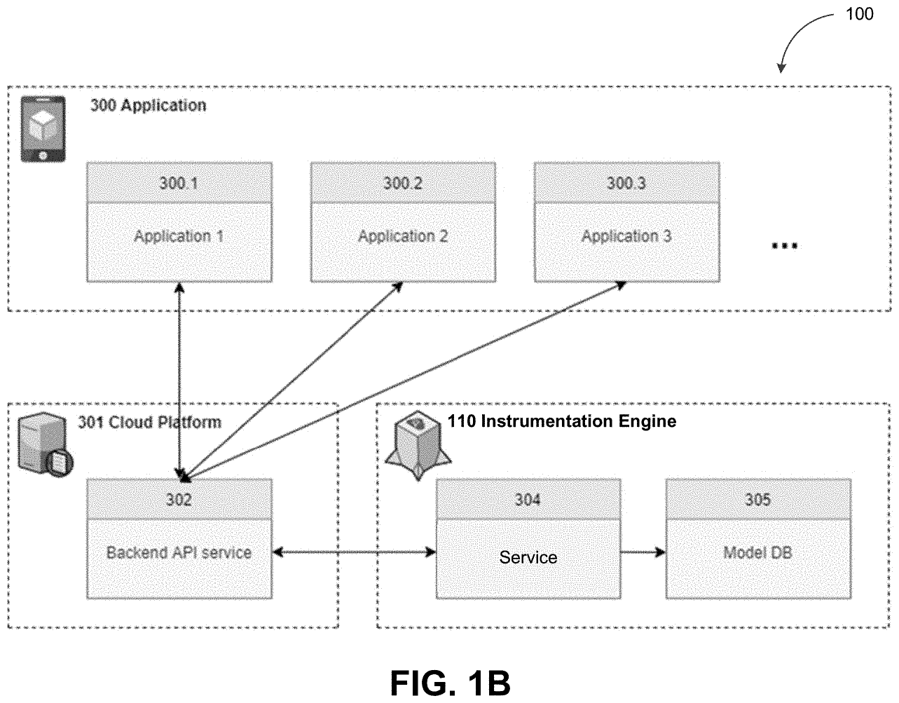

FIG. 1A depicts a system diagram illustrating an example of an instrumentation system 100, in accordance with some example embodiments. Referring to FIG. 1A, the instrumentation system 100 may include an instrumentation engine 110, a controller 120 coupled with a file repository 125, and a client device 130. As shown in FIG. 1A, the instrumentation engine 110, the controller 120, and the client device 130 may be communicatively coupled via a network 140. The client device 130 may be a processor-based device including, for example, a smartphone, a tablet computer, a wearable apparatus, a virtual assistant, an Internet-of-Things (IoT) appliance, and/or the like. The network 140 may be any wired and/or wireless network including, for example, a public land mobile network (PLMN), a wide area network (WAN), a local area network (LAN), a virtual local area network (VLAN), the Internet, and/or the like.

In some example embodiments, the instrumentation engine 110 may apply the learning model 115 in order to identify the attributes (e.g., security, globalization, and/or the like) impacted by an update to a software application 150 deployed, for example, at a production environment 155. In the example shown in FIG. 1A, a client device 130 may interact with the controller 120 to generate the update to the software application 150. The development controller 120 may include one or more software development applications and/or file repositories, which may be local at the client device 130 and/or cloud-based. In doing so, the client device 130 may modify or generate one or more files associated with the software application 150, which may be stored at the file repository 125 associated with the development controller 120. An attribute impact analysis of the one or more files may be triggered by the client device 130 interacting directly with the instrumentation engine 110, for example, through a user interface 135 at the client device 130. Alternatively and/or additionally, an attribute impact analysis of the one or more files may be triggered by the client device 130 committing the one or more files to the file repository 125, for example, by creating a pull request (PR) at the development controller 120.

Referring again to FIG. 1A, the instrumentation engine 110 may include a learning model 115 trained to identify the attributes impacted by a change to one or more files associated with the software application 150 such as configuration files, code files, and/or the like. For example, the learning model 115 may be trained to recognize a nexus or relationship between the name of a file containing a change to the programming code of the software application 150 and the attributes impacted by the file. Accordingly, when the learning model 115 encounters an update to the software application 150 that includes the file, the learning model 115 may identify one or more attributes impacted by the change to the programming code of the software application 150 based at least on the frequency of a file having a same (or similar) name being identified as impacting the same attribute. The files associated with the software application 150 may subsequently undergo a review (e.g., a targeted review) that is focused on the attributes identified as being impacted by the change to the programming code of the software application 150. The review may be more precise and resource efficient at least because the review may avoid those attributes not impacted by the change to the programming code of the software application. As such, the update to the software application 150 may be ready for deployment in less time and with less detriment to the functional availability of the software application 150.

FIG. 1B depicts a block diagram illustrating the architecture of an example of the instrumentation system 100, in accordance with some example embodiments. Referring to FIG. 1B, the instrumentation engine 110 may provide a service (e.g., an impact analysis service) 304, which may perform an attribute impact analysis by applying the learning model 115 stored, for example, in a model database 305. In the example of the instrumentation system 100 shown in FIG. 1B, the service 304 provided by the instrumentation engine 110 may be made available through one or more applications 300. The one or more applications 300 may include cloud-based applications hosted at the cloud platform 210 including, for example, a chat bot, a plug-in, and/or the like. The impact analysis service 304 may be triggered or invoked by the user at the client device 130 interacting with the one or more applications 300. For example, as shown in FIG. 1B, based on one or more inputs received from the client device 130, the one or more applications 300 may interact with the impact analysis service 304 provided by the instrumentation engine 110 through a backend application programming interface (API) service 302.

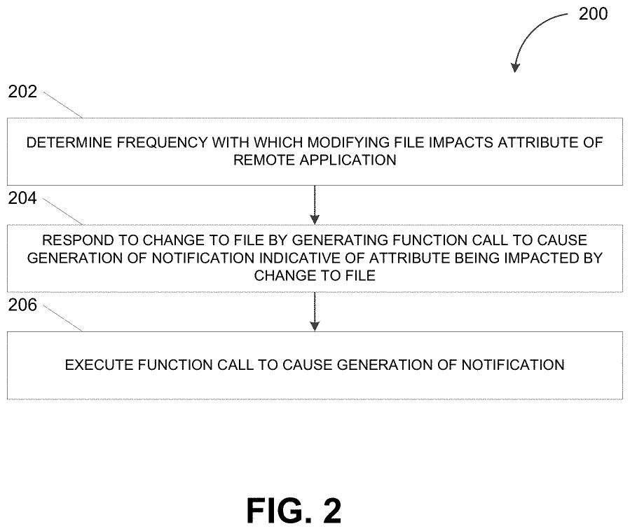

FIG. 2 depicts a flowchart illustrating an example of a process 200 for learning model based attribute impact analysis, in accordance with some example embodiments. Referring to FIGS. 1A-B and 2, the process 350 may be performed by the instrumentation engine 110 to identify one or more attributes (e.g., security, globalization, and/or the like) impacted by a change to one or more files associated with the software application 150 including, for example, configuration files, code files, and/or the like.

At 202, the instrumentation engine 110 may determine a frequency with which modifying a file impacts an attribute of a remote application. In some example embodiments, the instrumentation engine 110 may determine, based on a historical data, how frequently modifying a file impacts an attribute of a remote application such as the software application 150. Moreover, the instrumentation engine 110 may train the learning model 115 based on the frequency with which a modification to the file impacts the attribute of the software application 150. For example, the instrumentation engine 110 may determine the frequency with which modifying a file having the name “ABC” impacts the security and/or globalization attribute of the software application 150. Furthermore, the learning model 150 may be trained, based on this frequency, to recognize that modifying a file having the “ABC” impacts the security and/or globalization attribute of the software application 150.

At 204, the instrumentation engine 110 may respond to a change to the file by generating a function call to cause the generation of a notification indicative of the attribute being impacted by the change to the file. In some example embodiments, upon detecting a change to a file associated with the software application 150, the instrumentation engine 110 may apply the learning model 115 to determine that changing the file, which has the name “ABC” or a name that is sufficiently similar to “ABC,” impacts the security and/or globalization attribute of the software application 150. Accordingly, the instrumentation engine 110 may generate a function call configured to cause the software application 150 (and/or another remote application such as the development controller 120) to generate a notification identifying the security and/or globalization attributes impacted by the change to the file.

At 206, the instrumentation engine 110 may execute the function call to cause the generation of the notification. For example, the function call may be executed at the software application 150 (and/or another remote application) to generate a notification identifying the security and/or globalization attributes impacted by the change to the file. The notification may be sent to the client device 130 and displayed at the user interface 135. In some example embodiments, the notification may trigger and/or enable a review (e.g., a targeted review) of the one or more attributes impacted by the change to the file. The review may examine the attributes identified as being impacted by the changes made to the file and is therefore more precise and resource efficient.

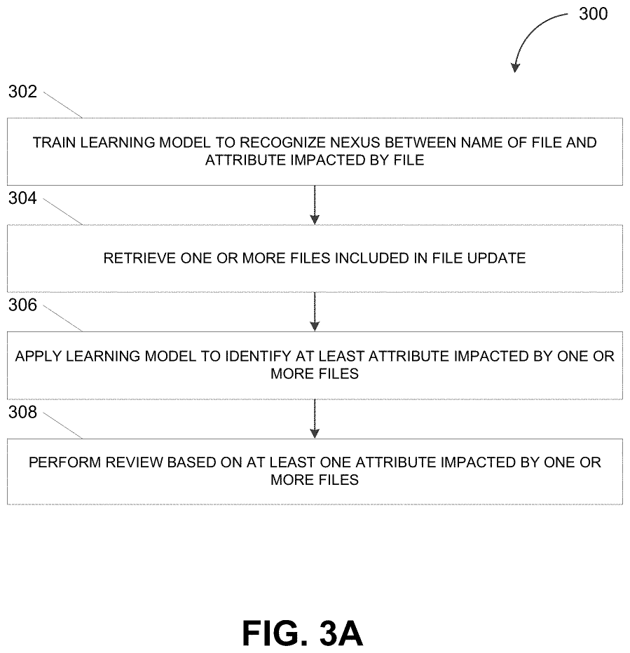

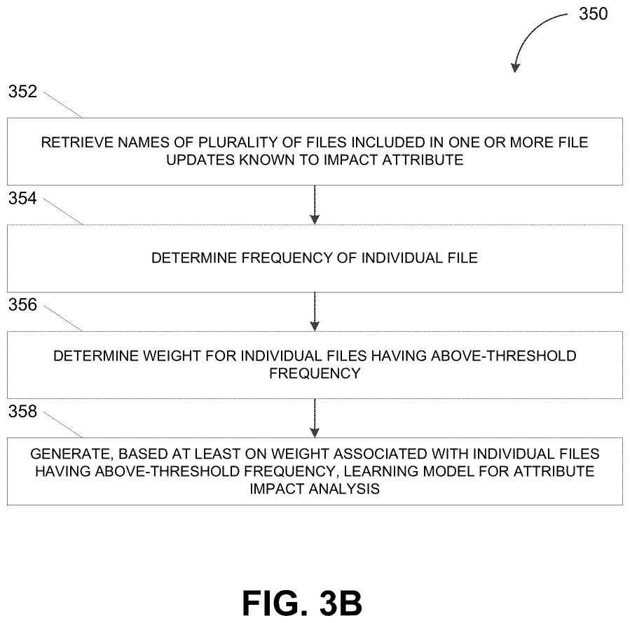

FIG. 3A depicts a flowchart illustrating an example of a process 300 for learning model based attribute impact analysis, in accordance with some example embodiments. Referring to FIGS. 1A-B and 3A, the process 300 may be performed by the instrumentation engine 110 to identify one or more attributes (e.g., security, globalization, and/or the like) impacted by a change to one or more files associated with the software application 150 including, for example, configuration files, code files, and/or the like.

At 302, the instrumentation engine 110 may train a learning model to recognize a nexus or relationship between a name of a file and an attribute impacted by the file. In some example embodiments, the learning model 115 be trained to recognize the file as impacting a particular attribute, such as security or globalization, based at least on a frequency of a file having a same (or similar) name being identified as impacting that attribute. Accordingly, when the instrumentation engine 110 encounters an update to a software application that includes the file, the learning model 115 may be applied to identify the attribute impacted by the update based at least on the frequency of the file having a same (or similar) name being identified as impacting that attribute.

At 304, the instrumentation engine 110 retrieve one or more files included in a file update. In some example embodiments, an attribute impact analysis of one or more files may be triggered by the user at the client device 130 interacting directly with the instrumentation engine 110, for example, through the user interface 135 at the client device 130. For example, the instrumentation engine 110 may receive, from the client device 130, a user input including an identifier of a ticket (e.g., an issue tracking ticket from an issue tracking application) associated with a file update in which the one or more files are committed to the file repository 125. Alternatively and/or additionally, an attribute impact analysis of the one or more files may be triggered by the user at the client device 130 committing the one or more files to the file repository 125, for example, by creating a pull request (PR) at the development controller 120. The instrumentation engine 110 may retrieve, based at least on the identifier of the file update (e.g., a commit identifier), the names of the one or more files included in the file update.

At 306, the instrumentation engine 110 may apply the learning model 115 to identify at least one attribute impacted by the one or more files. In some example embodiments, the learning model 115 may be trained to recognize a nexus or relationship between the name of a file containing the change to the programming code of the software application 150 and the attributes impacted by the file. Accordingly, for a file included in the file update, the learning model 115 may be applied to determine, based at least on the name of the file, a weight corresponding to how frequently a file having a same (or sufficiently similar) name is part of a file update known to impact a particular attribute. For example, the application of the learning model 115 may include determining a similarity metric between a first string corresponding a first name of a first file from the file update and a second string corresponding to a second name of a second file included in the learning model 115 to determine whether the second name of the second file is the same as (or sufficiently similar to) the first name of the first file. Examples of similarity metrics include edit distance, Minkowski distance, Manhattan distance, Euclidean distance, Hausdorff distance, Damerau-Levenshtein distance, Sorensen-Dice coefficient, block distance, Hamming distance, Jaro-Winkler distance, simple matching coefficient (SMC), Jaccard coefficient, Tversky index, overlap coefficient, variational distance, Hellinger distance, information radius, skew divergence, confusion probability, Tau metric, Fellegi and Sunters metric (SFS), maximal matches, grammar-based distance, and term frequency inverse document frequency (TFIDF) distance metric.

In the event the first name of the first file is determined to be the same as (or sufficiently similar to) the second name of the second file, the first file from the file update may be assigned a first score corresponding to the weight associated with the second file in the learning model 115. Moreover, if the file update also includes a third file that is determined to match one or more files included in the learning model 115, the instrumentation engine 110 may combine the first score of the first file and a second score of the third file.

In some example embodiments, if the combined scores of the first file and the third file satisfy a threshold value (e.g., associated with the learning model 115), the instrumentation engine 110 may determine that the file update (e.g., the corresponding ticket from the issue tracking system) impacts a particular attribute. However, if the combined scores of the first file and the third file does not satisfy the threshold value, the instrumentation engine 110 may determine whether the first file and the third file match one or more files that are associated with above-threshold weights in the learning model 115 (e.g., top x-percent weight). The instrumentation engine 110 may determine that the file update (e.g., the corresponding ticket from the issue tracking system) impacts a particular attribute if the first file and the third file match one or more files that are associated with above-threshold weights in the learning model 115. Contrastingly, the instrumentation engine 110 may determine that the file update does not impact a particular attribute if the first file and/or the third file do not match one or more files that are associated with above-threshold weights in the learning model 115.

At 308, the instrumentation engine 110 may perform, based on the at least one attribute impacted by the one or more files, a review (e.g., a targeted review). In some example embodiments, the programming code associated with the software application 150 may subsequently undergo a review that is focused on the attributes identified as being impacted by the change to the programming code of the software application 150. The review may be more precise and resource efficient such that the update to the software application 150 may be ready for deployment in less time and with less detriment to the functional availability of the software application 150.

As noted, in some example embodiments, the learning model 115 may be trained to recognize a nexus or relationship between the name of a file and the attributes impacted by the file. To further illustrate, FIG. 3B depicts a flowchart illustrating an example of a process 350 for training the learning model 115 to perform attribute impact analysis, in accordance with some example embodiments. The process 350 may implement, for example, operation 302 of the process 300 shown in FIG. 3A. For example, in some example embodiments, the instrumentation engine 110 may train the learning model 115 based on file updates and/or files that are known to impact one or more attributes such as security, globalization, and/or the like.

At 352, the instrumentation engine 110 may retrieve the names of a plurality of files included in one or more file updates known to impact an attribute. In some example embodiments, the instrumentation engine 110 may train the learning model 115 based on file updates that are known to impact a specific attribute such as security, globalization, and/or the like. For example, an issue tracking application may include tickets identifying the attribute impacted by one or more file updates in which one or more files are committed to the file repository 125 in response to a ticket issued by the issue tracking application. The instrumentation engine 110 may determine the identifier associated with individual file updates. Moreover, the instrumentation engine 110 may retrieve, based at least on the identifier associated with a file update, the names of the files included in the file update.

At 354, the instrumentation engine 110 may determine the frequency of individual files. In some example embodiments, the instrumentation engine 110 may determine, based at least on the name of each file, a corresponding frequency indicative of how frequently individual files are a part of a file update known to impact a particular attribute. For example, the instrumentation engine 110 may increment the frequency of a first file having the first name “ABC” each time the instrumentation engine 110 encounters a file having the same (or a sufficiently similar) name. In some cases, the instrumentation engine 110 may compute a similarity metric (or string metric) between a first text string corresponding the first name of the first file and a second text string corresponding to the second name of a second file to determine whether the second name of the second file is the same as (or is sufficiently similar to) the first name of the first file. Accordingly, the instrumentation engine 110 may increment the frequency of the first file having the first name “ABC” if the similarity metric between the first name of the first file and the second name of the second file satisfy a threshold value.

The similarity metric between the first text string and the second text string may correspond to a distance between the first text string and the second text string. For example, in some instances, the distance between the first text string and the second text string may correspond to a quantity of edits (e.g., substitutions, deletions, and/or the like) required to transform the first text string into the second text string. Examples of similarity metrics include edit distance, Minkowski distance, Manhattan distance, Euclidean distance, Hausdorff distance, Damerau-Levenshtein distance, Sorensen-Dice coefficient, block distance, Hamming distance, Jaro-Winkler distance, simple matching coefficient (SMC), Jaccard coefficient, Tversky index, overlap coefficient, variational distance, Hellinger distance, information radius, skew divergence, confusion probability, Tau metric, Fellegi and Sunters metric (SFS), maximal matches, grammar-based distance, and term frequency inverse document frequency (TFIDF) distance metric.

At 356, the instrumentation engine 110 may determine a weight for individual files having an above-threshold frequency. In some example embodiments, the instrumentation engine 110 may determine, for a file known to impact an attribute, a weight corresponding to a ratio between the frequency of the file and the aggregate frequency of all files known to impact the attribute. In some cases, the instrumentation engine 110 may determine a weight for individual files having an above-threshold frequency. That is, the instrumentation engine 110 may exclude, from the learning model 115, files whose frequencies do not satisfy a threshold value. For instance, for an n-quantity of files having the corresponding frequencies (F₁, F₂, F₃, . . . , Fₙ), the weight Wₓ for a file having the frequency Fₓ may be computed based on Equation (1) below.

$${W}_{x} = \frac{100}{( {F}_{1} + {F}_{2} + {F}_{3} + … + {F}_{n} ) \times {F}_{x}} \qquad ( 1 )$$

At 358, the instrumentation engine 110 may generate, based at least on the weight associated with individual files having an above-threshold frequency, a trained learning model. In some example embodiments, the instrumentation engine 110 may generate the learning model 115 to include the weights determined for individual files. Moreover, the learning model 115 may be associated with a threshold weight value. Whether a file included in a file update impacts a particular attribute may be determined based at least on whether the weight associated with the file exceeds this threshold weight value.

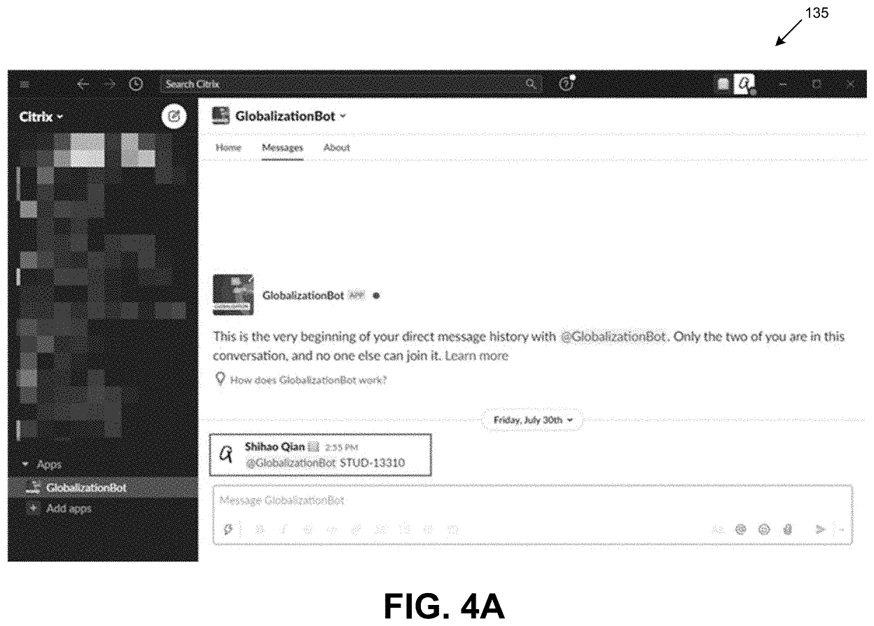

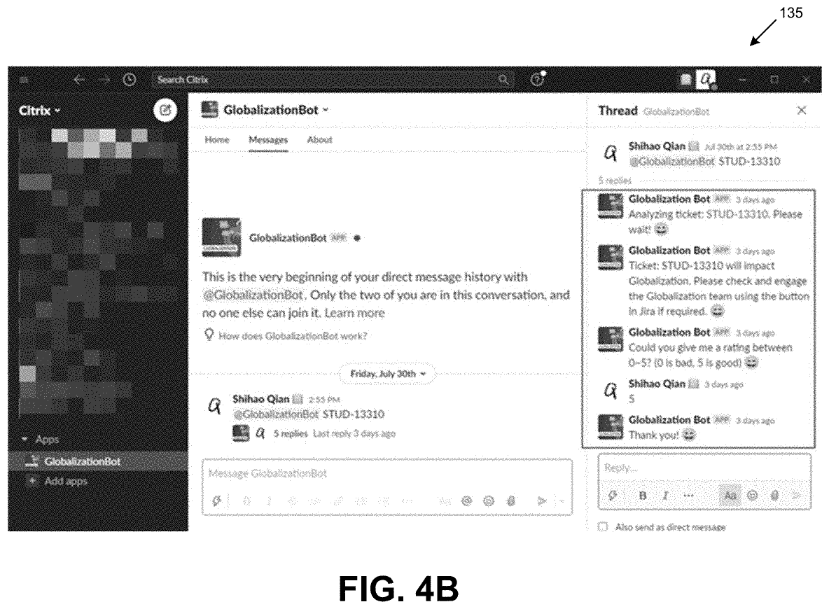

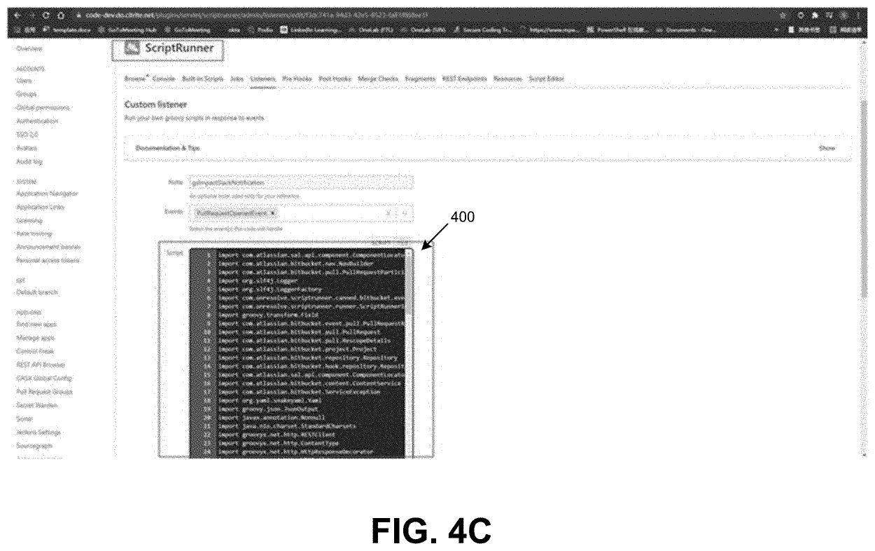

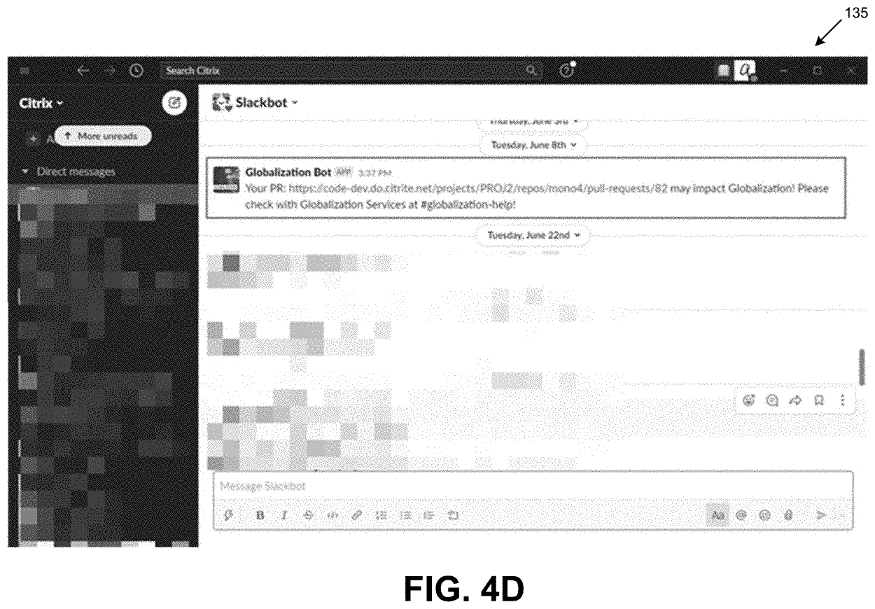

As noted, in some example embodiments, an attribute impact analysis of the one or more files may be triggered by the client device 130 interacting directly with the instrumentation engine 110, for example, through a user interface 135 at the client device 130. To further illustrate, FIGS. 4A-B depict screenshots illustrating examples of the user interface 135 at the client device 130 interacts with one or more applications 300 (e.g., a chat bot, a plug-in, and/or the like) to trigger or invoke the impact analysis service 304 provided by the instrumentation engine 110. In the example of the user interface 135 shown in FIG. 4A, the user interface 135 may receive one or more inputs identifying an issue (e.g., a ticket) by an issue tracking application (e.g., a ticket identifier “STU-13310”). In response to receiving the one or more user inputs identifying the ticket, the instrumentation engine 110 may perform an attribute impact analysis by at least retrieving the files included in the file update associated with the ticket. Moreover, as shown in FIG. 4B, the user interface 135 may be updated to provide a response identifying the one or more attributes (e.g., globalization) impacted by the file update associated with the issue or ticket.

Alternatively and/or additionally, an attribute impact analysis of the one or more files may be triggered by the user at the client device 130 committing the one or more files to the file repository 125, for example, by creating a pull request (PR) at the development controller 120. FIG. 4C depicts a screenshot illustrating an example of a script 400, which may be deployed at the development controller 120. Referring to FIG. 4D, in response to the client device 130 committing one or more files to the file repository 125 by generating a corresponding pull request (PR), the script 400 may be executed at the deployment controller 120 to perform an attribute impact analysis on the one or more files. The example of the user interface 135 shown in FIG. 4D shows the result of the attribute impact analysis including an identification of the one or more attributes (e.g., globalization) impacted by the one or more files.

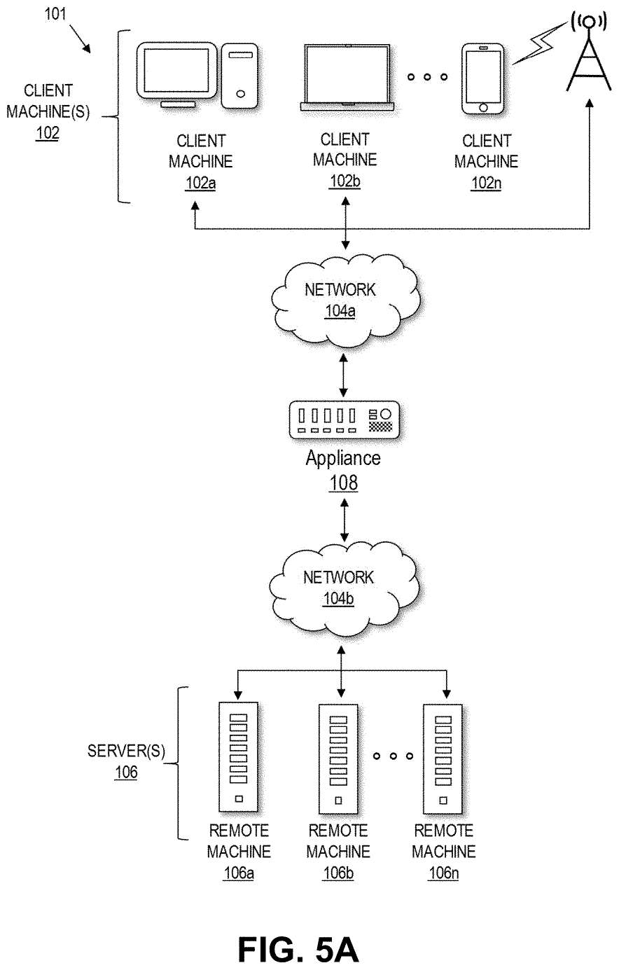

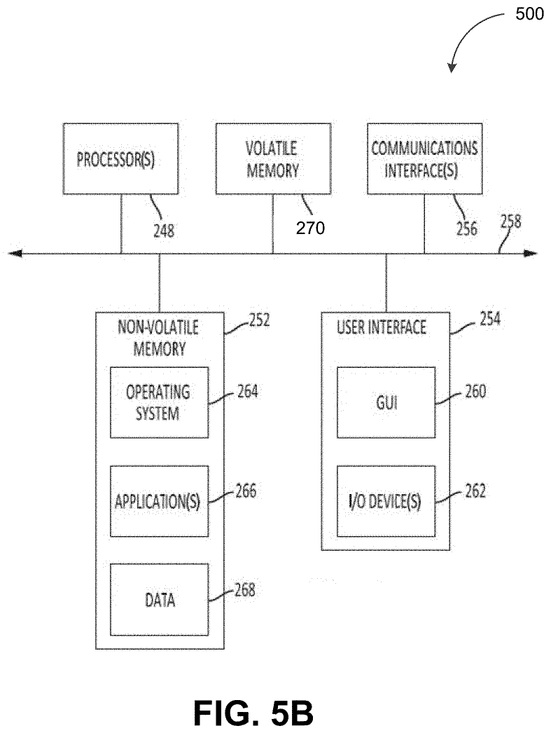

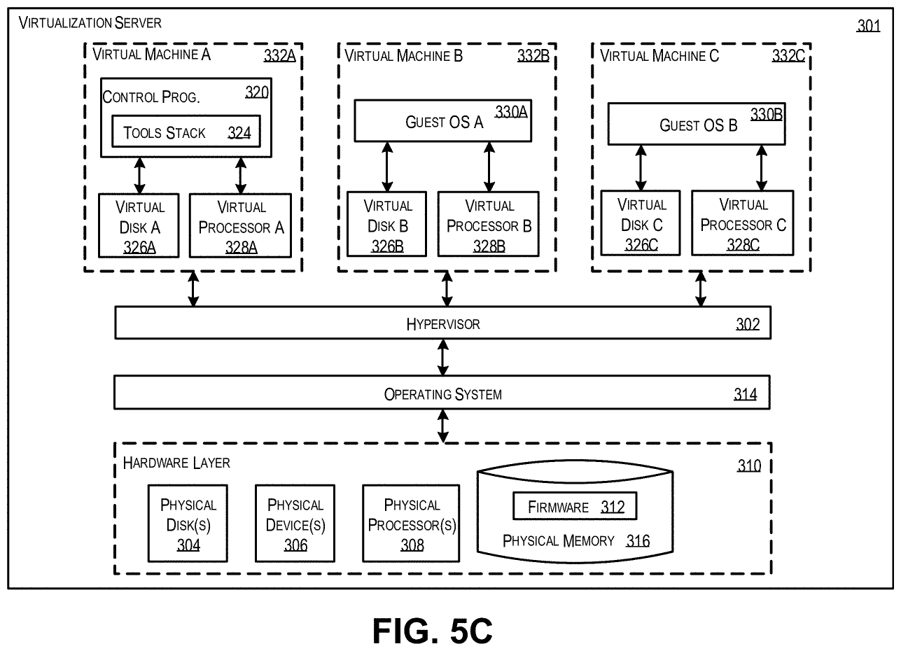

FIG. 5A depicts a network diagram illustrating an example of a network environment 101, in accordance with some example embodiments. Referring to FIGS. 1A and 5A, the network environment 101 in which various aspects of the disclosure may be implemented may include one or more client machines 102a-102n, one or more remote machines 106a-106n, one or more networks 104a and 104b, and one or more appliances 108 installed within the network environment 101. The client machines 102a-102n communicate with the remote machines 106a-106n via the networks 104a and 104b.

In some example embodiments, the client machines 102a-102n may communicate with the remote machines 106a-106n via an appliance 108. The illustrated appliance 108 is positioned between the networks 104a and 104b, and may also be referred to as a network interface or gateway. In some example embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example embodiments, multiple appliances 108 may be used, and the appliance(s) 108 may be deployed as part of the network 104a and/or 104b.

The client machines 102a-102n may be generally referred to as client machines, local machines, clients, client nodes, client computers, client devices, computing devices, endpoints, or endpoint nodes. The client machines 102a-102n may include, for example, the client machine 102 and/or the like. The remote machines 106a-106n may be generally referred to as servers or a server farm. In some example embodiments, a client 120 may have the capacity to function as both a client node seeking access to resources provided by a server 106 and as a server 106 providing access to hosted resources for other client machines 102a-102n. The networks 104a and 104b may be generally referred to as a network 104. The network 104 including the networks 104a and 104b may be configured in any combination of wired and wireless networks.

The servers 106 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. The servers 106 may include, for example, the instrumentation engine 110 and/or the like.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example embodiments, a server 106 may execute a remote presentation services program or other program that uses a thin-client or a remote-display protocol to capture display output generated by an application executing on a server 106 and transmit the application display output to a client machine 102.

In yet other example embodiments, a server 106 may execute a virtual machine providing, to a user of a client machine 102, access to a computing environment. The client machine 102 may be a virtual machine. The virtual machine may be managed by, for example, a hypervisor, a virtual machine manager (VMM), or any other hardware virtualization technique within the server 106.

In some example embodiments, the network 104 may be a local-area network (LAN), a metropolitan area network (MAN), a wide area network (WAN), a primary public network, and/or a primary private network. Additional embodiments may include one or more mobile telephone networks that use various protocols to communicate among mobile devices. For short-range communications within a wireless local-area network (WLAN), the protocols may include 802.11, Bluetooth, and Near Field Communication (NFC).

FIG. 5B depicts a block diagram illustrating an example of a computing device 500, in accordance with some example embodiments. Referring to FIGS. 1A and 5A-B, the computing device 500 may be useful for practicing an embodiment of the first client machine 102a, the second client machine 102b, the third client machine 102c, the fourth client machine 102d, and/or the instrumentation engine 110.

As shown in FIG. 5B, the computing device 500 may include one or more processors 248, volatile memory 270 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 may include a graphical user interface (GUI) 260 (e.g., a touchscreen, a display, and/or the like) and one or more input/output (I/O) devices 262 (e.g., a mouse, a keyboard, and/or the like). The non-volatile memory 252 may store an operating system 264, one or more applications 266, and data 268 such that computer instructions of the operating system 264 and/or applications 266 are executed by the processor(s) 248 out of the volatile memory 270. Data may be entered using an input device of the GUI 260 or received from I/O device(s) 262. Various elements of the computing device 500 may communicate via communication the communication bus 258. The computing device 500 as shown in FIG. 5B is shown merely as an example, as the first client machine 102a, the second client machine 102b, the third client machine 102c, the fourth client machine 102d, and/or the instrumentation engine 110 may be implemented by any computing or processing environment and with any type of machine or set of machines that may have suitable hardware and/or software capable of operating as described herein.

The processor(s) 248 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example embodiments, the “processor” may be one or more physical processors or one or more “virtual” (e.g., remotely located or “cloud”) processors.

The communications interfaces 256 may include one or more interfaces to enable the computing device 500 to access a computer network such as a local area network (LAN), a wide area network (WAN), a public land mobile network (PLMN), and/or the Internet through a variety of wired and/or wireless or cellular connections.

As noted above, in some example embodiments, one or more computing devices 500 may execute an application on behalf of a user of a client computing device (e.g., the clients 120), may execute a virtual machine, which provides an execution session within which applications execute on behalf of a user or a client computing device (e.g., the clients 120), such as a hosted desktop session, may execute a terminal services session to provide a hosted desktop environment, or may provide access to a computing environment including one or more of: one or more applications, one or more desktop applications, and one or more desktop sessions in which one or more applications may execute.

FIG. 5C depicts a high-level architecture of an example of a virtualization system for implementing the computing system 110, in accordance with some example embodiments. As shown in FIG. 5C, the virtualization system may be a single-server or multi-server system, or a cloud system, including at least one virtualization server 301 configured to provide virtual desktops and/or virtual applications to one or more client access devices 120a-c. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 301 may be configured as a virtualization server in a virtualization environment, for example, a single-server, multi-server, or cloud computing environment. Virtualization server 301 illustrated in FIG. 5C may be deployed as and/or implemented by one or more embodiments of server 106 illustrated in FIG. 5A or by other known computing devices. Included in virtualization server 301 is hardware layer 310 that may include one or more physical disks 304, one or more physical devices 306, one or more physical processors 308, and one or more physical memories 316. In some embodiments, firmware 312 may be stored within a memory element in physical memory 316 and be executed by one or more of physical processors 308. Virtualization server 301 may further include operating system 314 that may be stored in a memory element in physical memory 316 and executed by one or more of physical processors 308. Still further, hypervisor 302 may be stored in a memory element in physical memory 316 and be executed by one or more of physical processors 308. Presence of operating system 314 may be optional such as in a case where the hypervisor 302 is a Type A hypervisor.

Executing on one or more of physical processors 308 may be one or more virtual machines 332A-C (generally 332). Each virtual machine 332 may have virtual disk 326A-C and virtual processor 328A-C. In some embodiments, first virtual machine 332A may execute, using virtual processor 328A, control program 320 that includes tools stack 324. Control program 320 may be referred to as a control virtual machine, Domain 0, Dom0, or other virtual machine used for system administration and/or control. In some embodiments, one or more virtual machines 332B-C may execute, using virtual processor 328B-C, guest operating system 330A-B (generally 330).

Physical devices 306 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 5C illustrates an embodiment where firmware 312 is stored within physical memory 316 of virtualization server 301. Programs or executable instructions stored in physical memory 316 may be executed by the one or more processors 308 of virtualization server 301.

Virtualization server 301 may also include hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 may be any combination of executable instructions and hardware that monitors virtual machines 332 executing on a computing machine. Hypervisor 302 may be a Type 2 hypervisor, where the hypervisor executes within operating system 314 executing on virtualization server 301. Virtual machines may then execute at a layer above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, may provide virtual resources to guest operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for virtual machine 332 executing on virtualization server 301. Examples of hypervisor 302 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 301 may execute hypervisor 302 that creates a virtual machine platform on which guest operating systems 330 may execute. When this is the case, virtualization server 301 may be referred to as a host server. An example of such a virtualization server is Citrix Hypervisor® provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create virtual machine 332. The virtual machine image may refer to a collection of data, states, instructions, etc. that make up an instance of a virtual machine. In other embodiments, hypervisor 302 may execute guest operating system 330 within virtual machine 332. In still other embodiments, virtual machine 332 may execute guest operating system 330.

In addition to creating virtual machines 332, hypervisor 302 may control the execution of at least one virtual machine 332. The hypervisor 302 may present at least one virtual machine 332 with an abstraction of at least one hardware resource provided by virtualization server 301 (e.g., any hardware resource available within hardware layer 310). In some implementations, hypervisor 302 may control the manner in which virtual machines 332 access physical processors 308 available in virtualization server 301. Controlling access to physical processors 308 may include determining whether virtual machine 332 should have access to processor 308, and how physical processor capabilities are presented to virtual machine 332.

As shown in FIG. 5C, the virtualization server 301 may host or execute one or more virtual machines 332. Virtual machine 332 may be a set of executable instructions and/or user data that, when executed by processor 308, may imitate the operation of a physical computer such that virtual machine 332 can execute programs and processes much like a physical computing device. While FIG. 5C illustrates an embodiment where virtualization server 301 hosts three virtual machines 332, in other embodiments virtualization server 301 may host any number of virtual machines 332. Hypervisor 302 may provide each virtual machine 332 with a unique virtual view of the physical hardware, including memory 316, processor 308, and other system resources 304, 306 available to that virtual machine 332. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include virtual disk 326A-C (generally 326) and virtual processor 328A-C (generally 328.) Virtual disk 326 may be a virtualized view of one or more physical disks 304 of virtualization server 301, or a portion of one or more physical disks 304 of virtualization server 301. The virtualized view of physical disks 304 may be generated, provided, and managed by hypervisor 302. In some embodiments, hypervisor 302 may provide each virtual machine 332 with a unique view of physical disks 304. These particular virtual disk 326 (included in each virtual machine 332) may be unique, when compared with other virtual disks 326.

Virtual processor 328 may be a virtualized view of one or more physical processors 308 of virtualization server 301. The virtualized view of physical processors 308 may be generated, provided, and managed by hypervisor 302. Virtual processor 328 may have substantially all of the same characteristics of at least one physical processor 308. Virtual processor 308 may provide a modified view of physical processors 308 such that at least some of the characteristics of virtual processor 328 are different from the characteristics of the corresponding physical processor 308.

One or more aspects or features of the subject matter described herein can be realized in digital electronic circuitry, integrated circuitry, specially designed application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the least one data processor, cause the at least one data processor to at least:
determine, based at least on a historical data, a frequency with which modifying a file impacts an attribute of a first remote application;
in response to a change to the file, generate a function call to cause the first remote application and/or a second remote application to generate a notification indicative of the attribute being impacted by the change to the file; and
execute the function call to cause the first remote application and/or the second remote application to generate the notification.

2. The system of claim 1, wherein the at least one processor is further caused to at least:
train, based at least on the frequency with which modifying the file impacts the attribute of the first remote application, a learning model recognize a nexus between a name of the file and the attribute impacted by modifying the file;
apply the trained learning model to identify at least one attribute impacted by a file update including one or more files; and
perform a review of the at least one attribute impacted by the file update.

3. The system of claim 2, wherein the at least one data processor is further caused to at least:
retrieve, for each file of a plurality of files included in one or more file updates known to impact the at least one attribute, a corresponding name;
determine a frequency of each file having a same or similar name;
determine a weight for each file having an above-threshold frequency; and
generate, based at least on the weight associated with each file having the above-threshold frequency, the trained learning model.

4. The system of claim 3, wherein the at least one data processor is further caused to at least:
compute a similarity metric between a first text string corresponding a first name of a first file from the file update and a second text string corresponding to a second name of a second file included in the trained learning model; and
assign, to the first file, a first weight corresponding to a second weight of the second file in the trained learning model.

5. The system of claim 4, wherein the similarity metric comprises one or more of edit distance, Minkowski distance, Manhattan distance, Euclidean distance, Hausdorff distance, Damerau-Levenshtein distance, Sorensen-Dice coefficient, block distance, Hamming distance, Jaro-Winkler distance, simple matching coefficient (SMC), Jaccard coefficient, Tversky index, overlap coefficient, variational distance, Hellinger distance, information radius, skew divergence, confusion probability, Tau metric, Fellegi and Sunters metric (SFS), maximal matches, grammar-based distance, or term frequency inverse document frequency (TFIDF) distance metric.

6. The system of claim 3, wherein the at least one data processor is further caused to at least:
determine, based at least on a combined weight of the one or more files satisfying a first threshold value, that the file update impacts the at least one attribute.

7. The system of claim 6, wherein the at least one data processor is further caused to at least:
in response to the combined weight of the one or more files failing to satisfy the first threshold value, determine whether an individual weight of each of the one or more files satisfy a second threshold value; and
determine, based at least on the individual weight of each of the one or more files satisfying the second threshold value, that the file update impacts the at least one attribute.

8. The system of claim 3, wherein the weight associated with each file corresponds to a ratio between the frequency of each file and an aggregate frequencies of all files known to impact the attribute.

9. The system of claim 2, wherein the at least one data processor is further caused to at least:
retrieve, based at least on an identifier of the file update, the one or more files included in the file update.

10. The system of claim 2, wherein the at least one data processor is further caused to at least:
receive a user input including an identifier of an issue tracking ticket associated with the file update; and
apply the trained learning model to identify the at least one attribute impacted by the one or more files in response to user input.

11. The system of claim 2, wherein the at least one data processor is further caused to at least:
detect a pull request (PR) committing the one or more files; and
apply the trained learning model to identify the at least one attribute impacted by the one or more files in response to detecting the pull request.

12. The system of claim 1, wherein the attribute comprises security or globalization.

13. A computer-implemented method, comprising:
determining, based at least on a historical data, a frequency with which modifying a file impacts an attribute of a first remote application;
in response to a change to the file, generating a function call to cause the first remote application and/or a second remote application to generate a notification indicative of the attribute being impacted by the change to the file; and
executing the function call to cause the first remote application and/or the second remote application to generate the notification.

14. The method of claim 13, further comprising:
training, based at least on the frequency with which modifying the file impacts the attribute of the first remote application, a learning model recognize a nexus between a name of the file and the attribute impacted by modifying the file;
applying the trained learning model to identify at least one attribute impacted by a file update including one or more files; and
performing a review of the at least one attribute impacted by the file update.

15. The method of claim 14, further comprising:
retrieving, for each file of a plurality of files included in one or more file updates known to impact the at least one attribute, a corresponding name;
determining a frequency of each file having a same or similar name;
determining a weight for each file having an above-threshold frequency; and
generating, based at least on the weight associated with each file having the above-threshold frequency, the trained learning model.

16. The method of claim 15, further comprising:
computing a similarity metric between a first text string corresponding a first name of a first file from the file update and a second text string corresponding to a second name of a second file included in the trained learning model; and
assigning, to the first file, a first weight corresponding to a second weight of the second file in the trained learning model.

17. The method of claim 15, further comprising:
determining, based at least on a combined weight of the one or more files satisfying a first threshold value, that the file update impacts the at least one attribute;
in response to the combined weight of the one or more files failing to satisfy the first threshold value, determining whether an individual weight of each of the one or more files satisfy a second threshold value; and
determining, based at least on the individual weight of each of the one or more files satisfying the second threshold value, that the file update impacts the at least one attribute.

18. The method of claim 15, wherein the weight associated with each file corresponds to a ratio between the frequency of each file and an aggregate frequencies of all files known to impact the attribute.

19. The method of claim 13, further comprising:
retrieving, based at least on an identifier of the file update, the one or more files included in the file update.

20. A non-transitory computer readable medium storing instructions, which when executed by at least one data processor, result in operations comprising:
determining, based at least on a historical data, a frequency with which modifying a file impacts an attribute of a first remote application;
in response to a change to the file, generating a function call to cause the first remote application and/or a second remote application to generate a notification indicative of the attribute being impacted by the change to the file; and
executing the function call to cause the first remote application and/or the second remote application to generate the notification.
